(19) United States
(12) Patent Application Publication
(10) Pub. No.: US 2009/0257750 A1
(43) Pub. Date: Oct. 15, 2009

(54) Optical code division multiplex communication method, system, and module

(75) Inventors: Shuko Kobayashi, Kanagawa (JP); Kensuke Sasaki, Kanagawa (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/379,971

(22) Filed: Mar. 5, 2009

(30) Foreign Application Priority Data
Apr. 14, 2008 (JP) 2008-104857

(51) Int. Cl. H04J 14/00

(52) U.S. Cl. 398/77

(57) ABSTRACT

An optical communication system uses superstructured fiber Bragg gratings (SSFBGs) to encode and decode an optical pulse signal transmitted between two optical communication devices. Each SSFBG has uniformly spaced fiber Bragg gratings, producing a chip pulse train with a uniform phase difference between chips. The phase difference defines a code. There is one SSFBG at one of the two devices and two or more SSFBGs at the other device, using different codes to encode or decode the same optical signal. Using one code to encode and multiple codes to decode, or multiple codes to encode and one code to decode, provides a high signal-to-noise ratio and permits stable performance despite environmental temperature variations. For bidirectional communication, each communication device has at least three SSFBGs, divided into a transmitting group and a receiving group, mounted on a mounting plate with a negative thermal expansion coefficient.

### BACKGROUND OF THE INVENTION

1. Field of the Invention

The present invention relates to optical code division multiplexing, more particularly to an optical code division multiplexing method, system, and module that use multiple codes for encoding or decoding on the same communication channel.

2. Description of the Related Art

With the spread of the Internet in recent years, communication demand is growing rapidly. To address this expanding need for communication, high-speed large-capacity optical networks using optical fibers are being developed. Optical multiplexing is an essential transmission technology in these networks, enabling multiple optical signal channels to be transmitted simultaneously on a single optical fiber.

Several types of optical multiplexing are being intensively studied, including optical time division multiplexing (OTDM), wavelength division multiplexing (WDM), and optical code multiplexing (OCDM). OCDM can be used to increase the channel capacity of the other two techniques by enabling multiple channels to be transmitted in the same time slot or on the same wavelength. The different channels are distinguished by being modulated (encoded) with different codes. Since the receiving apparatus must use the same code to demodulate an encoded channel, OCDM also provides a measure of enhanced security.

Known OCDM systems include both wavelength-hopping/time-spreading systems and phase-coding systems. A wavelength-hopping/time-spreading OCDM system separates an optical pulse signal into optical chip pulse signals of different individual wavelengths; the allocation sequence of the wavelengths to the optical chip pulses constitutes the code. In a phase-coding system, the optical chip pulse signals have the same wavelength and the code is defined by the sequence of relative phase differences between the chip pulses.

One type of encoder and decoder widely used in OCDM employs a fiber Bragg grating (FBG). An FBG is an optical fiber with a diffraction grating formed inside its core to reflect light of a particular wavelength. The encoders and decoders in phase-coding OCDM systems usually employ a superstructured fiber Bragg grating (SSFBG) having a plurality of identical FBGs (unit FBGs) in the same optical fiber. The intervals between adjacent unit FBGs determine the code. Typically, the intervals are either zero or have a prescribed positive length. For a 15-bit phase code, for example, fifteen unit FBGs may be spaced to produce a chip pulse train with a sequence of phases such as the following

0, 0, 0, π, π, π, π, 0, π, 0, π, π, 0, 0, π,

in which the phase difference between successive chip pulses is either zero or π radians, as shown by the present inventors et al. in Japanese Patent Application Publication No. 2005-173246.

When this chip pulse train passes through the decoder SSFBG in the receiving apparatus, the resulting decoded optical signal waveform shows a strong autocorrelation peak. When signals on other channels are received by the decoder, since they have been encoded with different codes, the decoded signal waveforms have only comparatively weak cross-correlation peaks. The decoder is therefore able to receive the signal on the intended channel and disregard the signals on other channels by a simple thresholding process.

The signal-to-noise ratio given by the optical contrast ratio between autocorrelation peak and the cross-correlation peaks, however, is only about four (S/N=4). When many channels are multiplexed, the autocorrelation peak can become smaller than the sum of the cross-correlation peaks on different channels, making it impossible to receive the intended signal without a further process such as a time gating process.

The present inventors have discovered that by using codes in which the chip pulses have a fixed phase difference of 2aπ/N, where a is the channel number and N is the number of channels, a signal-to-noise ratio in excess of twenty-five (S/N>25) can be obtained. This type of code, however, is sensitive to ambient temperature variations, and precise temperature control is required to keep the phase difference constant.

### SUMMARY OF THE INVENTION

An object of the present invention is to provide an OCDM module that does not require precise SSFBG temperature control, an OCDM communication system using this module, and an optical code division multiplex communication method for use in the system.

Briefly, the invention provides an OCDM communication system and method that use multiple parallel SSFBGs, encoding or decoding the same data signal with different codes, at one end of each communication channel. Only one SSFBG need be used at the other end.

More specifically, the invention provides an OCDM communication system for communicating between a first communication device and a second communication device. The first communication device includes an SSFBG having a plurality of mutually identical unit fiber Bragg gratings disposed in a single optical fiber. The second communication device includes at least two such SSFBGs. All of these SSFBGs may be dedicated to a single unidirectional communication channel between the first and second devices.

The plurality of unit fiber Bragg gratings in each SSFBG are preferably equally spaced, so that they spread an input light pulse into a train of chip pulses with a constant phase difference between the chip pulses. The phase difference determines the code of the SSFBG. The SSFBGs preferably produce phase differences Δφ(N, a) of the form 2aπ/N, where N is the number of available codes and a is an integer from one to N.

If the direction of communication is from the first communication device to the second communication device, the SSFBG in the first communication device encodes the optical signal to be transmitted by using one code, and the SSFBGs in the second communication device decode the received signal by using two or more codes, which may or may not include the code used for encoding. The decoded signals are additively combined to obtain a single received signal.

If the direction of communication is from the second communication device to the first communication device, the SSFBGs in the second communication device encode the same signal, using different codes. The resulting encoded signals are additively combined and sent to the first communication device as a combined signal. The SSFBG at the first communication device decodes the combined signal to obtain a decoded signal, using a code that may or may not be identical to one of the codes used for encoding.

The use of one code for encoding and multiple codes for decoding, or multiple codes for encoding and one code for decoding, provides a high signal-to-noise ratio and stable performance under environmental temperature variations. If three consecutive codes are used for encoding or decoding at one communication device and the middle one of the three codes is used for decoding or encoding at the other communication device, for example, then transmission will remain stable despite temperature variations that cause the phase difference to wander in the interval between the phase differences of the outermost two of the three codes.

For bidirectional communication, the invention provides an OCDM module including at least three SSFBGs, divided into a transmitting group and a receiving group. One of the two groups may include only one SSFBG. The SSFBGs are preferably mounted on a mounting plate having a negative coefficient of thermal expansion and provide a single bidirectional communication channel that can operate without temperature control over a range of ambient temperatures from, for example, 0° C. to 80° C.

An OCDM communication system in which multiple communication channels are multiplexed onto a single optical fiber may be implemented by using a different set of codes for each communication channel.

### BRIEF DESCRIPTION OF THE DRAWINGS

In the attached drawings:

FIG. 1 is a schematic sectional side view of an SSFBG;

FIG. 2 is a diagram illustrating the coding and decoding of an optical pulse when the encoder and the decoder use the same code;

FIG. 3 is a diagram illustrating the coding and decoding of an optical pulse when the encoder and the decoder use different codes;

FIG. 4 is a graph illustrating calculated signal intensity ratios;

FIG. 5 is a schematic plan view of an OCDM module embodying the invention;

FIG. 6 is a graph illustrating the temperature dependence of the center wavelength of reflection in an SSFBG;

FIG. 7 is a schematic block diagram of an OCDM communication system embodying the invention;

FIG. 8 is a graph indicating received power in the OCDM module; and

FIGS. 9, 10, and 11 are schematic block diagrams of other OCDM communication systems embodying the invention.

### DETAILED DESCRIPTION OF THE INVENTION

Embodiments of the invention will now be described with reference to the attached non-limiting drawings, in which like elements are indicated by like reference characters.

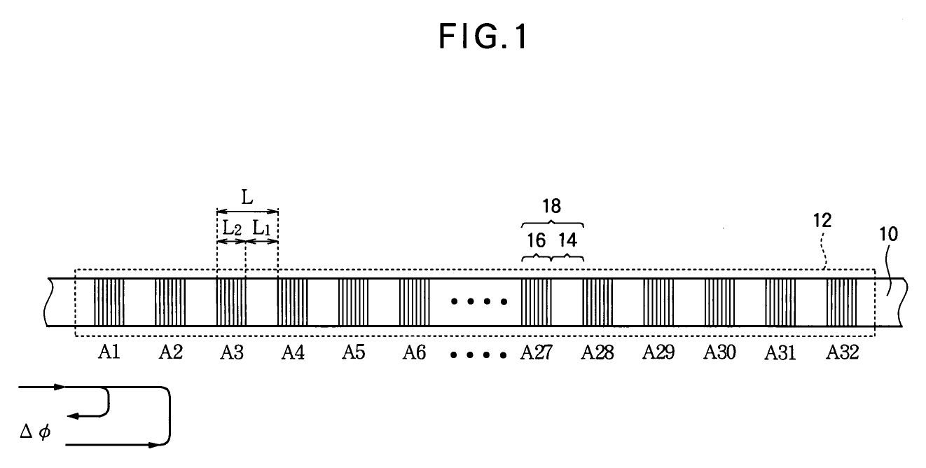

The embodiments employ SSFBGs of the general type shown in FIG. 1, formed in an optical fiber 10. The optical fiber 10 may be a single-mode optical fiber having a core doped with germanium or an equivalent substance to provide increased ultraviolet photosensitivity. The SSFBG 12 has a multi-point phase shift structure including a plurality of phase shifting regions 14 interspersed between a plurality of unit fiber Bragg gratings (unit FBGs) 16. The phase shifting regions 14 have identical lengths L₁. The unit FBGs 16 have identical lengths L₂ and identical internal structures. A pair consisting of a unit FBG 16 and an adjacent phase adjustment region 14 form a unit chip 18 of length L. Exemplary length values are 1.0 mm (L₁), 0.3 mm (L₂), and 1.3 mm (L).

In OCDM communication, the SSFBGs 12 used for encoding and decoding both include M unit FBGs 16, where M is an integer greater than one, equal to the code length. In FIG. 1 there are thirty-two unit FBGs 16, denoted A1, A2, . . . , A32 (M=32).

An optical pulse signal input to the SSFBG 12 is reflected by the unit FBGs 16 to generate M optical chip pulses. Because the unit FBGs 16 are equally spaced, the M optical chip pulses are equally spaced on the time axis. The optical chip pulses reflected by mutually adjacent pairs of unit FBGs 16 become mutually consecutive optical chip pulses having a uniform phase difference Δφ, which defines the code. This type of code, with a fixed phase difference between chip pulses, will be referred to as a cyclic phase code.

The number of different codes that may be used will be denoted by the letter N, representing an integer equal to or greater than two. The a-th one of the N codes will be denoted code {N-a}, where a is an integer from one to N. The phase difference Δφ between adjacent optical chip pulses in this code, denoted Δφ(N, a), is given by the following equation (1).

Δφ(N, a)=2aπ/N (1)

The value 2aπ/N is in radians. The phase difference Δφ(N, a) may also be expressed simply as a fraction of N, omitting the constant 2π, so that Δφ(N, a)=a/N.

The code length M is equal to the number of codes N, or to an integer multiple of N.

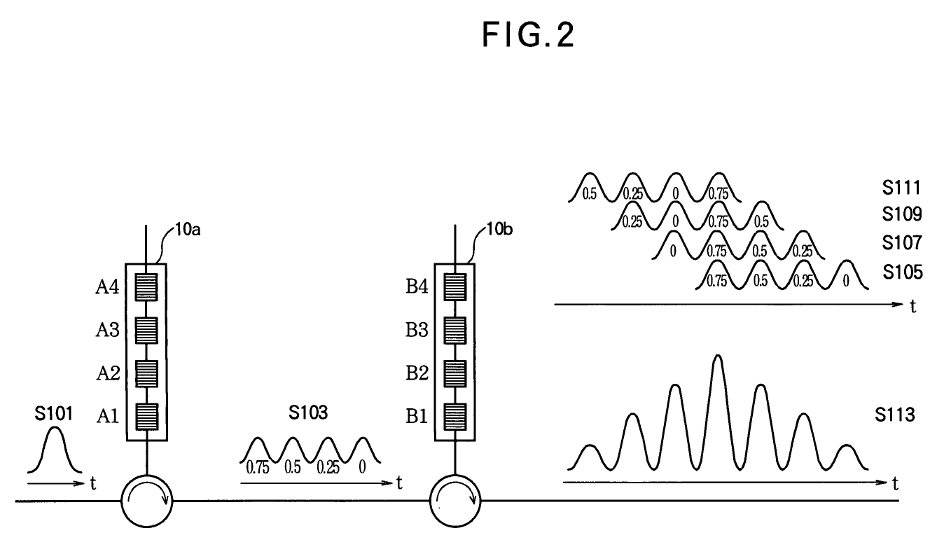

The encoding and decoding of a light pulse by an encoder and a decoder using the same code will be described with reference to FIG. 2. In this example, the code length M and the number of codes N are both 4.

The SSFBG in the encoder 10a used in the transmitting communication device has four unit FBGs 16, denoted A1, A2, A3, A4. The decoder 10b used in the receiving communication device has four unit FBGs 16, denoted B1, B2, B3, and B4.

From equation (1) above, the phase difference Δφ{4, 1} corresponding to the first code {4−1} is 0.25 (=¼). The encoder and the decoder both use this code; that is, the SSFBGs in both the encoder 10a and the decoder 10b are constructed to have this phase difference.

A fixed proportion of the input optical pulse signal S101 is reflected by each of the unit fiber Bragg gratings A1 to A4 in the encoder 10a. Accordingly, the input optical pulse signal S101 is divided into four chip pulses and output as an encoded signal S103. Since the intervals at which the unit fiber Bragg gratings A1 to A4 are arranged, that is, length L of the unit chip 18, is constant, the four chip pulses are spaced at equal intervals on the time axis. The phase difference Δφ between adjacent chip pulses on the time axis is constant.

The chip pulse reflected by the p-th unit fiber Bragg grating Ap (where p is an integer from one to M) will be referred to as the p-th chip pulse.

If the phase of the first chip pulse is 0, the phases of the second, third, and fourth chip pulses are 0.25, 0.5, and 0.75, respectively, because the phase difference Δφ{4, 1} is 0.25.

When the first to fourth chip pulses enter the decoder lob, each of them generates a further train of four chip pulses, which will be referred to as subchip pulses below. The decoder 10b accordingly outputs four subchip pulse trains S105, S107, S109, S111.

The chip pulse reflected by the p-th unit fiber Bragg grating Ap in the encoder 10a is delayed by an amount corresponding to

(p−1)×2×L

in comparison with the chip pulse reflected by the first unit fiber Bragg grating A1. The subchip pulse reflected by the q-th unit fiber Bragg grating Bq (q is an integer in the range of 1 to M in the decoder 10b is delayed by an amount corresponding to

(q−1)×2×L

in comparison with the subchip pulse reflected by the first unit fiber Bragg grating B1.

The subchip pulse reflected by the p-th unit fiber Bragg grating Ap of the encoder 10a and the q-th unit fiber Bragg grating Bq of the decoder 10b is delayed by an amount corresponding to

$$( p - 1 ) \times 2 \times L + ( q - 1 ) \times 2 \times L = ( p + q - 2 ) \times 2 \times L$$

in comparison with the subchip pulse reflected by the first unit fiber Bragg grating A1 in the encoder 10a and the first unit fiber Bragg grating B1 in the decoder 10b. As a result, all subchip pulses with equal values of p+q occupy identical positions on the time axis.

In the following description, the phase of the subchip pulse produced by reflection at the p-th FBG (Ap) in the encoder 10a and the q-th FBG (Qp) in the 10b will be denoted φ{p−q}. A phase value of 1 (2π radians) will be treated as zero (0).

When the first chip pulse enters the decoder 10b, a train S105 of four subchip pulses is output. If the phase φ{1−1} of the first subchip pulse is set equal to zero, the phases of the four subchip pulses are

(φ{1−1}, φ{1−2}, φ{1−3}, φ{1−4})=(0, 0.25, 0.5, 0.75).

Similarly, the phases of the train S107 of subchip pulses obtained from the second chip pulse are

(φ{2−1}, φ{2−2}, φ{2−3}, φ{2−4})=(0.25, 0.5, 0.75, 0),

the phases of the train S109 of subchip pulses obtained from the third chip pulse are

(φ{3−1}, φ{3−2}, φ{3−3}, φ{3−4}}=(0.5, 0.75, 0, 0.25}.

and the phases of the train S111 of subchip pulses obtained from the fourth chip pulse are

(φ{4−1), φ{4−2), φ{4−3), φ{4−4)}={0.75, 0, 0.25, 0.5}.

The subchip pulses with equal values of p+q, which occupy identical positions on the time axis, have identical phase values. For example, the phase values φ{1−4}, φ{2−3}, φ{3−2}, φ{4−1} of the subchip pulses satisfying the condition p+q=5 are all equal to 0.75. This produces a strong peak in the autocorrelation waveform S113.

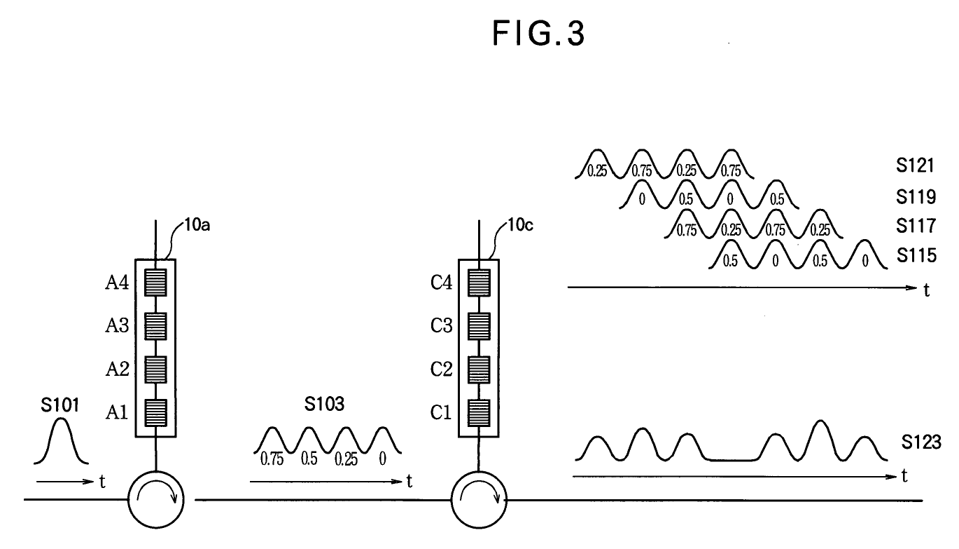

The coding and decoding of a light pulse by an encoder and a decoder using different codes will be described with reference to FIG. 3. In this example the encoder 10a uses code {4−1}, and the decoder 10c uses code {4−2}. The corresponding phase values Δφ{4, 1} and Δφ{4, 2} are 0.25 and 0.5, respectively.

If the phase φ{1−1} of the first (1−1-th) subchip pulse is set to zero, the phases of the resulting train S115 of four subchip pulses are

(φ{1−1}, φ{1−2}, φ{1−3}, φ{1−4})=(0, 0.5, 0, 0.5).

The phases of the train S117 of subchip pulses obtained from the second chip pulse are

(φ{2−1}, φ{2−2}, φ{2−3}, φ{2−4})=(0.25, 0.75, 0.25, 0.75),

the phases of the train S119 of subchip pulses obtained from the third chip pulse are

(φ{3−1}, φ{3−2}, φ{3−3}, φ{3−4}}=(0.5, 0, 0.5, 0),

and the phases of the train S121 of subchip pulses obtained from the fourth chip pulse are

(φ{4−1), φ{4−2), φ{4−3) , φ{4−4)}={0.75, 0.25, 0.75, 0.25}.

Among the subchip pulses with equal values of p+q, which occupy identical positions on the time axis, some pairs have a phase difference of 0.5 (=π radians). The subchip pulses in such a pair have opposite phases and cancel each other out by destructive mutual interference. For example, if the value of p+q is 5, the phase value φ{1−4} is 0.5 while the phase value φ{3−2} is 0, so the difference is 0.5, and the phase value φ{2−3} is 0.25 while the phase value φ{4−1} is 0.75, so the difference is again 0.5. Accordingly, the subchip pulses with phases of φ{1−4} and φ{3−2} interfere destructively, and the subchip pulses with phases of φ{2−3} and φ{4−1} also interfere destructively, producing a flat signal with no peak at this point in the autocorrelation waveform S123.

The above description applies regardless of the number of codes N. If N is 32, for example, Δφ{32, 1} is 1/32 while Δφ{32, 2} is 2/32, and phase φ{1−17} is 0 while phase φ{17−1} is 0.5. The subchips with phases of φ{1−17} and φ{17−1} accordingly interfere destructively.

With a cyclic phase code, if the encoder and the decoder use the same code, the subchip pulses that emerge from the decoder at the same time all have the same phase, providing a high signal intensity. If the encoder and the decoder use different codes, some pairs of chip pulses that emerge at the same time have opposite phases and cancel out, producing a low signal intensity.

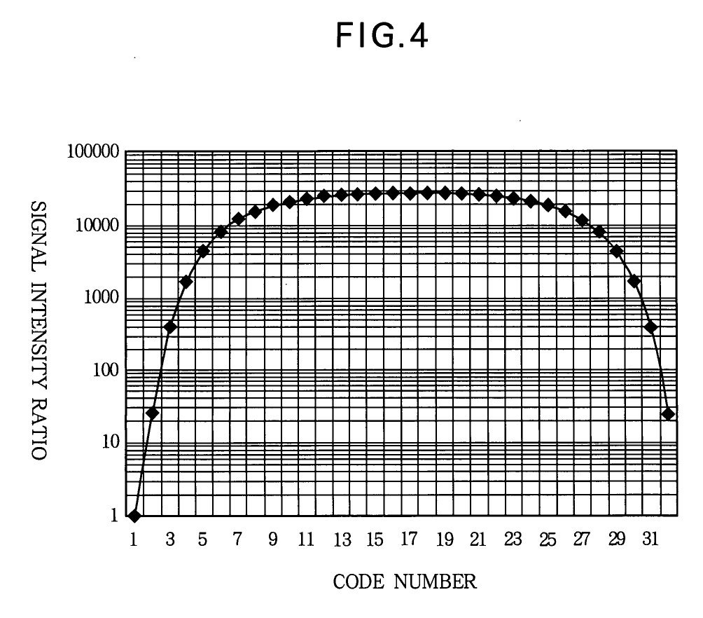

FIG. 4 is a graph illustrating calculated signal intensity ratios when a signal encoded by a encoder having code {32−1} is decoded. The horizontal axis indicates the code used by the decoder, and the vertical axis indicates the signal intensity ratio, referenced to the case in which the decoder also uses code {32−1}. Since a signal encoded and decoded with different codes may have been transmitted on a different communication channel and thus represents cross-correlation noise, the signal intensity ratio will also be referred to as a signal-to-noise ratio.

When code {32−1} is used for decoding, an autocorrelation waveform is obtained and the signal-to-noise ratio is unity. When the adjacent codes {32−2} and {32−32} are used for decoding, a cross-correlation waveform is obtained and the signal-to-noise ratio is about 25. When the decoder uses non-adjacent codes {32−3} to {32−31}, the signal-to-noise ratio becomes higher, exceeding 100.

It can be seen from FIG. 4 that even with a high multiplexing rate, the autocorrelation waveform component will never be smaller than the total sum of the cross-correlation waveform components. The receiving device can accordingly identify the autocorrelation waveform component without a further process such as a time gating process.

As has been described above, the cyclic phase code makes it possible to increase the energy of the autocorrelation waveform component generated from an optical signal, and the signal intensity ratio (signal-to-noise ratio) of the autocorrelation waveform component with respect to the cross-correlation waveform components.

Although an encoder using a cyclic phase code is no more complicated than a conventional encoder using a non-cyclic phase code and can be manufactured by the same methods, the encoder using the cyclic phase code provides a greatly increased signal-to-noise ratio. As the signal-to-noise ratio increases, the reliability of signal reception increases.

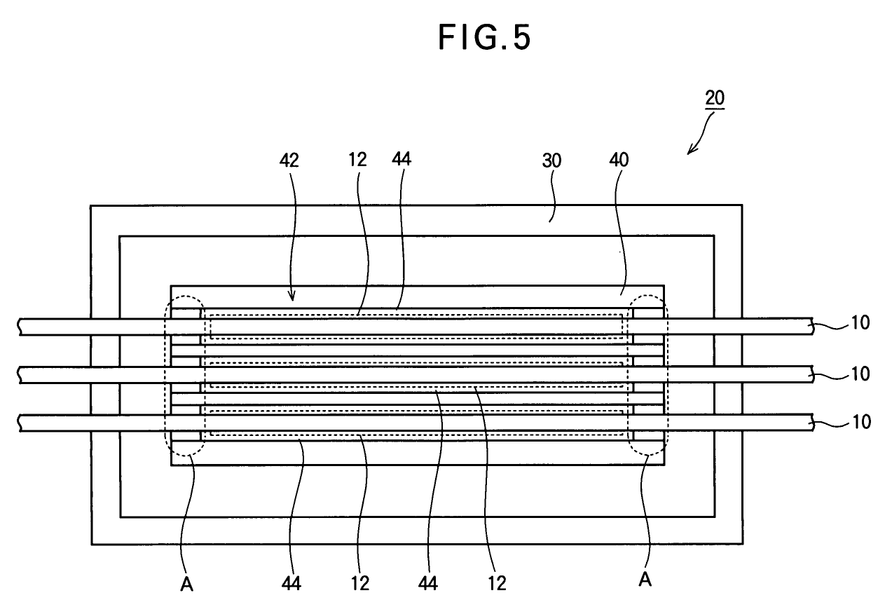

An OCDM module embodying the present invention will now be described with reference to the plan view in FIG. 5.

The OCDM module 20 has k superstructured fiber Bragg gratings (SSFBGs), k being an integer equal to or greater than three. The k SSFBGs 12 are mounted on a mounting plate 40 and placed in a housing 30. In the drawing, three SSFBGs 12 are mounted on the mounting plate 40 (k=3).

CERSAT, a glass ceramic material with a negative thermal expansion coefficient of −68×10⁻⁷ /° C., manufactured by Nippon Electric Glass Co., Ltd. of Tokyo, Japan, may be used for the mounting plate 40.

The mounting plate 40 here is a plate 5 mm thick. One face 42 has three grooves 44 in which the three SSFBGs 12 are placed. The mounting plate 40 preferably has an additional positioning groove (not shown) on at least one longitudinal edge.

The thermal expansion coefficient and outer dimensions of the mounting plate 40, the dimensions and sectional shape of the grooves 44 in which the SSFBGs 12 are placed, and other design parameters should be determined in accordance with the required temperature compensation capability, in view of the length of the SSFBGs 12, the refractive index variation in the unit fiber Bragg gratings, its temperature sensitivity, the difference between the thermal expansion coefficients of the mounting plate 40 and the optical fibers 10, and so on.

The SSFBGs 12 are attached by adhesive at both ends (A in the figure) of the mounting plate with a prescribed tension applied. The adhesive used here is the WR8774 ultraviolet/heat-curing epoxy adhesive manufactured by Kyoritsu Chemical & Co., Ltd. The adhesive used to attach the SSFBG 12 is not limited to the WR8774; other adhesives such as acrylic adhesives may be used. The Shore D hardness of the adhesive after curing is preferably 80 or greater, and the glass transition temperature is preferably 100° C. or higher.

The housing 30 can be formed from an inexpensive and easily workable material such as aluminum. The housing 30 has a body and a lid. The mounting plate 40 on which the SSFBGs 12 are mounted is placed in the body of the housing 30. The housing 30 is preferably box-shaped and has at least one positioning catch in a position corresponding to the positioning groove (if present) in the mounting plate 40. The lid is screwed onto the body after the SSFBGs 12 and other components have been placed inside.

When a cyclic phase code is used, ambient temperature variations and other environmental factors may cause the reflected wavelength to change from one value (λ₀) to another value (λ₁). Since phase differences defined in terms of wavelength λ₀ differ from phase differences defined in terms of wavelength λ₁, these environmental variations can change one code into another.

The effect of temperature changes will be described below using codes {32−1} and {32−2} as an example. From equation (1) above, the phase difference defining code {32−1} is 1/32×2π radians or more simply 1/32 (0.03125). The phase difference defining code {32−2} is 2/32×2π radians or 2/32 (0.06250). To change code {32−1} to code {32−2}, accordingly, it suffices to produce a phase variation of 0.03125 (0.06250−0.03125).

Suppose that code {32−1} is specified to give a phase difference of 0.03125 at reflection wavelength λ₀ when the temperature of the SSFBG is T₀. When the temperature of the SSFBG changes by ΔT to bring the reflection wavelength to λ₁, the thermal expansion ΔL and the refractive index change Δn accompanying the temperature change in each unit chip area change the phase difference Δφ between chip pulses by an amount δ(Δφ). This phase difference variation δ(Δφ) is given by the following equation (2).

δ(Δφ)=({ΔL×(n+Δn)}×2)/λ₀ (2)

If the thermal expansion coefficient of the optical fiber is 5.5×10⁻⁷/° C., the refractive index of the core is 1.45, the reflective index variation by temperature is 8.6×10⁻⁶/° C., and the temperature coefficient of the reflection wavelength variation is ten picometers per degree Celsius (10 pm/° C.), the above equation (2) yields the following equation (3).

δ(Δφ)={(L+5.5×10⁻⁷×ΔT×L)×(1.45+8.6×10⁻⁶×ΔT)×2}/λ₀ (3)

ΔT in this equation is the temperature change required to change the reflection wavelength from λ₀ to λ₁.

Suppose that the reflection wavelength λ₀ specified for temperature T₀ is 1549.32 nm and the unit chip length L is 1.3 mm. Substituting these values into the equation (3) yields a phase variation δ(Δφ) of 0.0157 for a temperature variation ΔT of 1° C. If the temperature of the encoder changes by 2° C., producing a reflection wavelength change of about 20 pm, code {32−1} changes to code {32−2}.

It is known that the center wavelength of reflection of an FBG varies with stress on the FBG and the ambient temperature (see, for example, U.S. Pat. No. 6,490,394 to Beall et al. or Fiber Bragg Gratings by Othonos et al., Artech House, May 1999). The wavelength variation Δλ_{B} is given by the following equation.

$$Δ {λ}_{B} = 2 \{ Λ ( \frac{\partial {n}_{eff}}{\partial l} ) + {n}_{eff} ( \frac{\partial Λ}{\partial l} ) \} Δ l + 2 \{ Δ ( \frac{\partial {n}_{eff}}{\partial T} ) + {n}_{eff} ( \frac{\partial Λ}{\partial T} ) \} Δ T \qquad ( 4 )$$

The first term of the above equation (4) expresses the strain-dependent wavelength variation Δλ_{B}_{_{—}}_{Strain}, which is given by the following equation (5).

Δλ_{B}_{_{—}}_{Strain}=λ_{B}(1−pₑ)ε_{z} (5)

The second term of equation (4) expresses the temperature-dependent wavelength variation Δλ_{B}_{_{—}}_{Temp}, which is given by the following equation (6).

Δλ_{B}_{_{—}}_{Temp}=λ_{B}ΔT{(1/Λ) (dΛ/dT)+(1/n_{eff}) (dn_{eff}/dT)} (6)

In equations (5) and (6) above, Δλ_{B} expresses the center wavelength of reflection at a reference temperature. In equation (5), ε_{z} denotes the amount of strain per unit length. The effective strain-optic constant pₑ is a function of the strain tensor component of the glass material forming the optical fiber, the Poisson ratio, and the effective refractive index of the optical fiber. In equation (6), ΔT denotes temperature change, Λ denotes the length of one period in the periodic refractive index structure in the FBG, and n_{eff} denotes the effective refractive index of the optical fiber.

When the ambient temperature increases, the temperature-dependent wavelength variation Δλ_{B}_{_{—}}_{Temp} takes a positive value, making the operating wavelength longer. When the ambient temperature decreases, temperature-dependent wavelength variation Δλ_{B}_{_{—}}_{Temp} takes a negative value, making the operating wavelength shorter.

If the ambient temperature increases, the mounting plate 40 shrinks, decreasing the distance between fixed points on the SSFBG and decreasing the tensile stress of the SSFBG mounted on the mounting plate. This reduces the refractive index period Λ, making the center wavelength of reflection shorter. If the ambient temperature decreases, the center wavelength of reflection becomes longer.

The strain-dependent wavelength variation Δλ_{B}_{_{—}}_{Strain} and the temperature-dependent wavelength variation Δλ_{B}_{_{—}}_{Temp} accordingly act in opposite directions: when one becomes longer, the other becomes shorter. As a result, the strain-dependent wavelength variation Δλ_{B}_{_{—}}_{Strain} compensates for the temperature-dependent wavelength variation Δλ_{B}_{_{—}}_{Temp}.

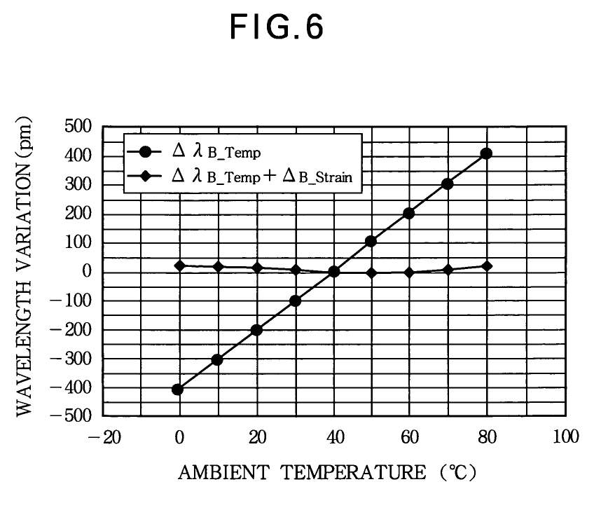

The effect of ambient temperature variation on the center wavelength of reflection in an SSFBG, with and without the above compensation, is illustrated in FIG. 6. The horizontal axis represents the ambient temperature (° C.), and the vertical axis represents the reflection wavelength variation (pm) referenced to the reflection wavelength at an ambient temperature of 40° C.

Without compensation, the temperature-dependent reflection wavelength variation Δλ_{B}_{_{—hd Temp}} (black circles in FIG. 6) is about 10 pm for a temperature variation ΔT of 1° C. The total reflection wavelength change over an ambient temperature range of 0° C. to 80° C. is about 800 pm.

If the SSFBG is mounted on a mounting plate having a negative thermal expansion coefficient, the reflection wavelength variation Δλ_{B} (black diamonds in FIG. 6) is the sum of the temperature-dependent wavelength variation Δλ_{B}_{_{—}}_{Temp} and the strain-dependent wavelength variation Δλ_{B}_{_{—}}_{Strain}. Since these variations compensate for each other, the maximum reflection wavelength variation Δλ_{B} is about 25 pm over the ambient temperature range from 0° C. to 80° C. These data were obtained with the SSFBG mounted under a tensile stress of about 40 to 50 grams (0.392 to 0.490 N).

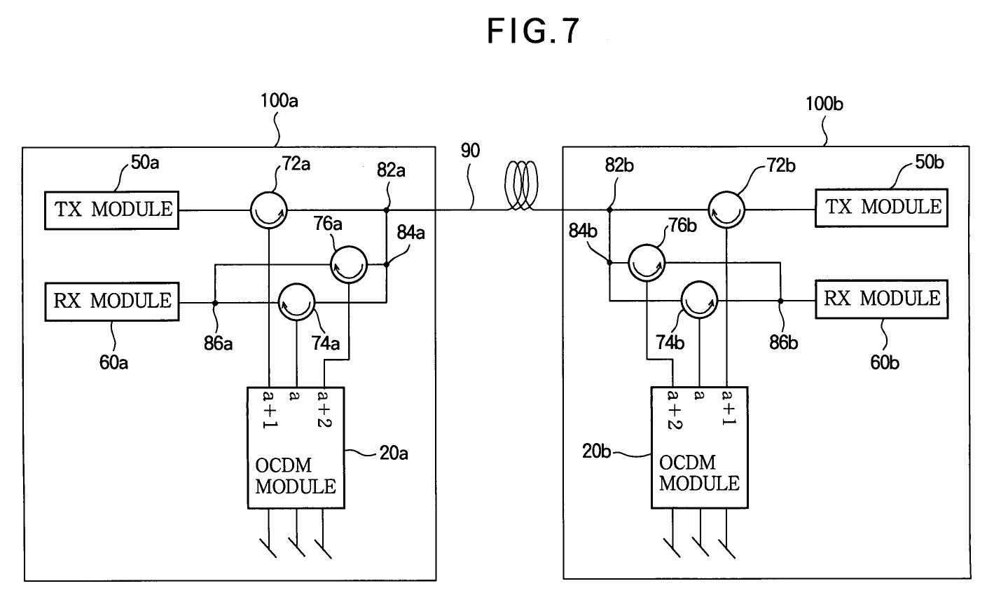

An OCDM communication device including the optical code division multiplexing module will be described with reference to FIG. 7, which shows a first OCDM communication device 100a and a second OCDM communication device 100b connected by an optical fiber 90.

Each OCDM communication device has an OCDM module in which the k SSFBGs are divided into two groups. The value of k is 3: one group has a single SSFBG functioning as a phase encoder; the other group has two SSFBGs functioning as a phase decoder. The OCDM communication devices also include optical circulators 72a, 72b, 74a, 74b, 76a, 76b and optical couplers 82a, 82b, 84a, 84b, and 86a, 86b.

The first OCDM communication device 100a includes a transmitting (Tx) module 50a, a receiving (Rx) module 60a, and an OCDM module 20a. The OCDM module 20a has a first group including one SSFBG functioning as a phase encoder and a second group including two SSFBGs functioning as phase decoders.

The second OCDM communication device 100b includes a transmitting module 50b, a receiving module 60b, and an OCDM module 20b. The OCDM module 20b has a first group including one SSFBG functioning as a phase encoder and a second group including two SSFBGs functioning as phase decoders.

The first OCDM communication device 100a, the second OCDM communication device 100b, and the optical fiber 90 interconnecting them form one bidirectional channel of an OCDM communication system. Signal transmission from the first OCDM communication device 100a to the second OCDM communication device 100b will be described below as an example. A signal can be transmitted from the second OCDM communication device 100b to the first OCDM communication device 100a in the same manner.

An optical pulse signal representing transmit data, generated by the transmitting module 50a in the first OCDM communication device 100a is sent through optical circulator 72a to the OCDM module 20a. The signal is encoded by the encoder in the OCDM module 20a, and the encoded signal returns to optical circulator 72a and is sent through optical coupler 82a to the second OCDM communication device 100b.

In the second OCDM communication device 100b, the signal received from the first OCDM communication device 100a passes through optical coupler 82b to optical coupler 84b. Optical coupler 84b splits the optical signal into two parts and sends the two parts through respective optical circulators 74b, 76b to the OCDM module 20b. The two parts of the optical signal are decoded by separate SSFBGs in the OCDM module 20b. The decoded signals returns through optical circulators 74b, 76b to optical coupler 86b, where they are additively combined to produce a decoded signal that is sent to the receiving module 60b.

FIG. 7 illustrates one bidirectional communication channel (channel one). In each OCDM module 20a, 20b, the single SSFBG in the first group encodes the transmit signal by using code {N−(a+1)}, and the two SSFBGs in the second group decode the received signal by using codes {N−a} and {N−(a+2)}, as indicated.

On the next communication channel (channel two), used by two other OCDM modules (not shown) in the same or other OCDM communication devices for bidirectional communication on the same optical fiber 90, the single SSFBG used as the encoder in the first group operates with code {N−(a+5)}, and the two SSFBGs used as decoders in the second group operate with codes {N−(a+4)} and {N−(a+6)}.

For example, if the code used by the encoder on channel one is {32−2}, the codes used by the decoders on channel one are {32−1} and {32−3}. If the code used by the encoder on channel two is {32−6}, the codes used by the decoders on channel two are {32−5} and {32−7}.

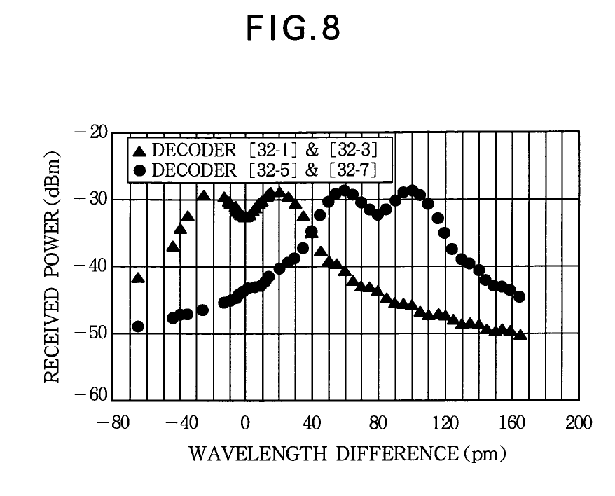

Even though signals coded with codes {32−2} and {32−6} are decoded by using different codes {32−1}, {32−3}, {32−5}, and {32−7}, adequate received power values and signal-to-noise ratios are obtained, as shown by the data in FIG. 8.

FIG. 8 indicates the power with which the signal transmitted in channel one, encoded with code {32−2}, is received when decoded by the OCDM module in channel one with codes {32−1} and {32−3} (black triangles) and when decoded by the OCDM module in channel two with codes {32−5} and {32−7} (black dots) under different temperature conditions. The horizontal axis represents the temperature-induced difference (pm) in reflection wavelength between the encoder and the decoder. The vertical axis represents the calculated received power (dBm).

If the difference in reflection wavelength between the encoder and the decoder is 40 pm or less, the received power on channel one is greater than the received power on channel two. If the difference in reflection wavelength is 26 pm or less, the received power ratio of channels one and two is ten decibels (10 dB) or greater. This ratio is high enough for the signal transmitted on channel one to be received successfully on channel one without causing crosstalk on channel two. Similarly, when the receiving device on channel one receives signals transmitted on both channels one and two, it can successfully receive the signal transmitted on channel one while disregarding the signal transmitted on channel two as noise.

Channels one and two are typically used in different environments such as different users' homes. If the SSFBGs are mounted on a mounting plate having a negative thermal expansion coefficient, the wavelength variation of the encoder and decoder is suppressed to at most about 25 pm over a range of ambient temperatures at least from 0° C. to 80° C. Over this temperature range, accordingly, each channel can be received successfully without interference from the other channel.

For more widely separated channels, the received power ratio becomes even higher and interference becomes substantially negligible. If the signal transmitted on channel three is encoded with code {32−10} and decoded with codes {32−9} and {32−11}, for example, extrapolation of the curves in FIG. 8 and the data in FIG. 4 indicate a received power ratio of 20 dB or more.

The arrangement above, in which the SSFBG using the (a+1)-th code belongs to the first group and functions as the encoder, and SSFBGs using the a-th code and the (a+2)-th code belong to the second group and function as decoders, is only one of many possible configurations.

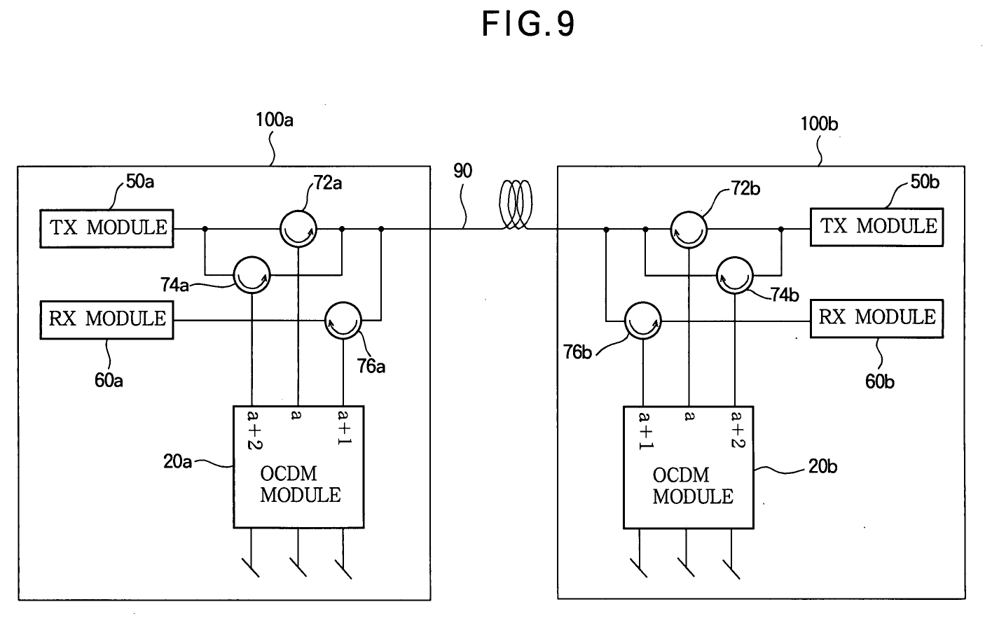

As shown in FIG. 9, the first group may be used as the decoder and the second group, may be used as the encoder. In the transmitting device, the optical pulse signal is split into two parts. The two split signals are encoded separately by the SSFBG using the a-th code and the SSFBG using the (a+2)-th code and are added to generate an encoded signal. The encoded signal is decoded by an SSFBG using the (a+1)-th code in the receiving device. The OCDM communication devices 100a, 100b in FIG. 9 differ from the OCDM communication devices 100a, 100b in FIG. 7 in that optical circulators 74a, 74b are connected in parallel with optical circulators 72a, 72b instead of optical circulators 76a, 76b.

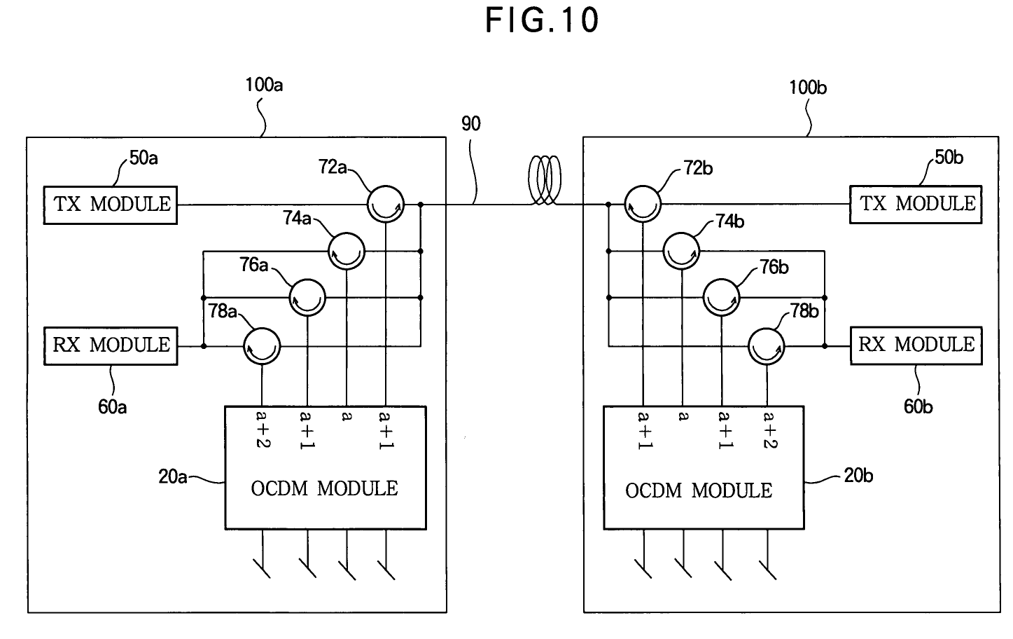

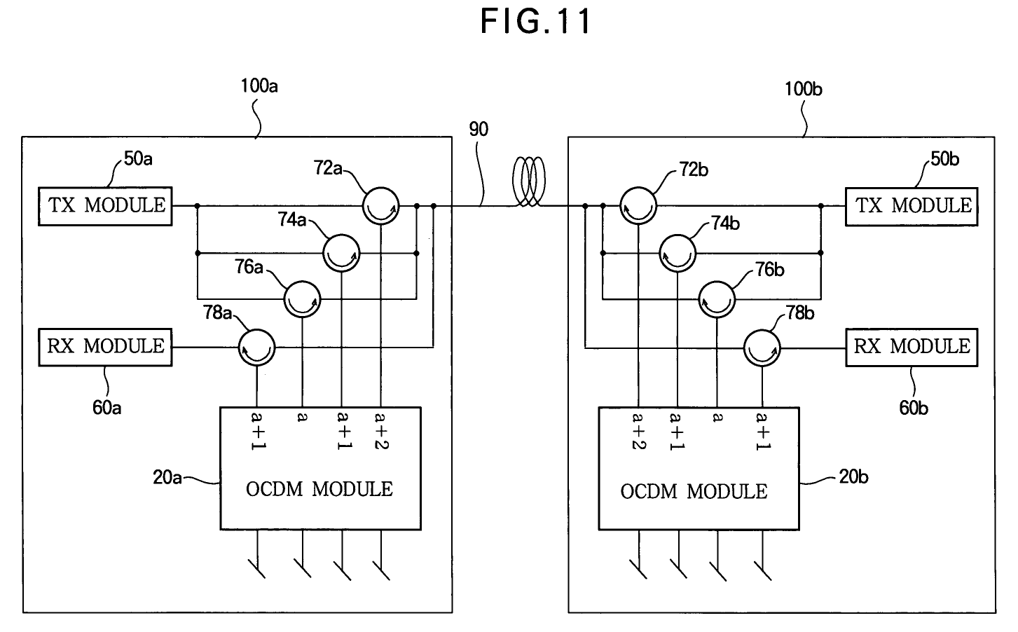

In another variation, the first group has three SSFBGs using three consecutive codes, and the second group has one SSFBG using the middle one of the three codes. Either group may be used for transmission, the other group being used for reception. Two examples are shown in FIGS. 11 and 12. The OCDM communication devices 100a, 100b in these examples have four optical circulators each. In FIG. 10, optical circulators 72a, 72b are connected to the transmitting modules 50a, 50b, and optical circulators 74a, 74b, optical circulators 76a, 76b, and optical circulators 78a, 78b are connected in parallel to the receiving modules 60a, 60b, so the (a+1)-th code is used for decoding and the a-th, (a+1)-th, and (a+2)-th codes are used for encoding. In FIG. 11, optical circulators 72a, 72b, optical circulators 74a, 74b, and optical circulators 76a, 76b are connected in parallel to the transmitting modules 50a, 50b, and optical circulators 78a, 78b are connected to the receiving modules 60a, 60b, so the a-th, (a+1)-th, and (a+2)-th codes are used for encoding and the (a+1)-th code is used for decoding.

The first group may have two SSFBGs using the a-th code and the (a+1)-th code, and the second group may have one SSFBG using either a-th code or the (a+1)-th code. Either group may be used for transmission, the other group being used for reception. The communication devices may have the same configuration as in FIG. 7 or FIG. 9, with the (a+2)-th code changed to the (a+1)-th code.

With the optical code division multiplexing method, system, and module of the present invention, a high signal-to-noise ratio can be provided by using cyclic phase codes, and the high signal-to-noise ratio can be maintained despite environmental temperature variations without requiring precise temperature control of the SSFBGs. If the mounting plate on which the SSFBGs are mounted is formed from a material having a negative thermal expansion coefficient, it will only be necessary to keep the SSFBG temperature within broad limits, such as within the range from 0° C. to 80° C. In typical indoor environments that always remain within this temperature range, no SSFBG temperature control is necessary at all.

As an optical fiber device, the OCDM module of the present invention has a simple and inexpensive configuration and is comparatively easy to manufacture. In comparison with code-variable OCDM encoders including an arrayed waveguide grating (AWG) or a planar light wave circuit (PLC), the OCDM module of the present invention has a smaller insertion loss in the optical fiber network that provides the transmission channel, can be downsized more easily, and costs less.

A few embodiments have been shown above, but those skilled in the art will recognize that further variations are possible within the scope of the invention, which is defined in the appended claims.

What is claimed is:

1. An optical code division multiplex module comprising k superstructured fiber Bragg gratings (SSFBGs), each SSFBG having a plurality of mutually identical unit fiber Bragg gratings disposed in a single optical fiber, k being an integer equal to or greater than three, the k SSFBGs being divided into a first group and a second group, the SSFBG(s) in one of the first group and the second group functioning as encoders, the SSFBG(s) in another one of the first group and the second group functioning as decoders.

2. The optical code division multiplex module of claim 1, wherein the k SSFBGs serve a single bidirectional communication channel.

3. The optical code division multiplex of claim 1, wherein the plurality of mutually identical unit fiber Bragg gratings in said each SSFBG are equally spaced.

4. The optical code division multiplex module of claim-3, wherein the number of unit fiber Bragg gratings in said each SSFBG is an integer M greater than one, a light pulse input to said each SSFBG is reflected by each of the unit fiber Bragg gratings in the SSFBG and thereby divided into M chip pulses, and in said each SSFBG there is a constant phase difference between the chip pulses reflected by mutually adjacent ones of the unit fiber Bragg gratings, the phase difference determining a code.

5. The optical code division multiplex module of claim 4, wherein the code is an a-th one of N codes, N being an integer greater than one, a being an integer from one to N, and the phase difference, expressed as Δφ(N, a), is
Δφ(N, a)=2aπ/N.

6. The optical code division multiplex module of claim 5, wherein for a certain positive integer a less than N, the k SSFBGs include:
an SSFBG using an (a+1)-th one of the N codes and belonging to the first group;
an SSFBG using the a-th one of the N codes and belonging to the second group; and
an SSFBG using an (a+2)-th one of the N codes and belonging to the second group.

7. The optical code division multiplex module of claim 5, wherein for a certain positive integer a less than N, the k SSFBGs include:
an SSFBG using an (a+1)-th one of the N codes and belonging to the first group;
an SSFBG using the a-th one of the N codes and belonging to the second group;
an SSFBG using the (a+1)-th one of the N codes and belonging to the second group; and
an SSFBG using an (a+2)-th one of the N codes and belonging to the second group.

8. The optical code division multiplex module of claim 5, wherein for a certain positive integer a less than N, the k SSFBGs include:
an SSFBG using the a-th or an (a+1)-th one of the N codes and belonging to the first group;
an SSFBG using the a-th one of the N codes and belonging to the second group; and
an SSFBG using the (a+1)-th one of the N codes and belonging to the second group.

9. The optical code division multiplex module of claim 1, further comprising a mounting plate on which the k SSFBGs are mounted, the mounting plate having a negative coefficient of thermal expansion.

10. An optical code division multiplex communication system, for performing optical code division multiplex communication between a first communication device and a second communication device, wherein:
the first communication device includes an SSFBG having a plurality of mutually identical unit fiber Bragg gratings disposed in a single optical fiber; and
the second communication device includes at least two SSFBGs, each one of the at least two SSFBGs having a plurality of mutually identical unit fiber Bragg gratings disposed in a single optical fiber.

11. The optical code division multiplex communication system of claim 9, wherein the SSFBG in the first communication device and the SSFBGs in the second communication device are dedicated to a single unidirectional communication channel between the first and second devices.

12. The optical code division multiplex communication system of claim 10, wherein the plurality of mutually identical unit fiber Bragg gratings in each SSFBG among the SSFBG in the first communication device and the at least two SSFBGs the second communication device are equally spaced.

13. The optical code division multiplex communication system of claim 12, wherein the number of unit fiber Bragg gratings in said each SSFBG is an integer M greater than one, a light pulse input to said each SSFBG is reflected by each of the unit fiber Bragg gratings in the SSFBG and thereby divided into M chip pulses, and in said each SSFBG there is a constant phase difference between the chip pulses reflected by mutually adjacent ones of the unit fiber Bragg gratings, the phase difference determining a code.

14. The optical code division multiplex communication system of claim 13, wherein the code is an a-th one of N codes, N being an integer greater than one, a being an integer from one to N, and the phase difference, expressed as Δφ(N, a), is
Δφ(N, a)=2aπ/N.

15. The optical code division multiplex communication system of claim 14, wherein for a certain positive integer a less than N:
the SSFBG in the first communication device has an (a+1)-th one of the N codes; and
the at least two SSFBGs in the second communication device include
an SSFBG using the a-th one of the N codes, and
an SSFBG using an (a+2)-th one of the N codes.

16. The optical code division multiplex communication system of claim 14, wherein for a certain positive integer a less than N:
the SSFBG in the first communication device has an (a+1)-th one of the N codes; and
the at least two SSFBGs in the second communication device include
an SSFBG using the a-th one of the N codes,
an SSFBG using the (a+1)-th one of the N codes, and
an SSFBG using an (a+2)-th one of the N codes.

17. The optical code division multiplex communication system of claim 14, wherein for a certain positive integer a less than N:
the SSFBG in the first communication device uses the a-th or the (a+1)-th one of the N codes; and
the at least two SSFBGs in the second communication device include
an SSFBG using the a-th one of the N codes, and
an SSFBG using the (a+1)-th one of the N codes.

18. The optical code division multiplex communication system of claim 10, wherein:
the first communication device further includes a first mounting plate on which the at least one SSFBG is mounted, the first mounting plate having a negative coefficient of thermal expansion; and
the second communication device further includes a second mounting plate on which the at least two SSFBGs are mounted, the second mounting plate having a negative coefficient of thermal expansion.

19. An optical code division multiplex communication method for optical code division multiplex communication between a transmitting communication device having a plurality of SSFBGs and a receiving communication device having one SSFBG, each SSFBG among the plurality of SSFBGs and the one SSFBG having M mutually identical unit fiber Bragg gratings disposed in a single optical fiber so as to reflect a light pulse input to the single optical fiber, thereby dividing the light pulse into M chip pulses, the method comprising:
arranging the M unit fiber Bragg gratings in said each SSFBG at equal intervals such that the chip pulses produced by reflection by mutually adjacent ones of the M unit fiber Bragg gratings differ in phase by a quantity Δφ(N, a) expressible as
Δφ(N, a)=2aπ/N
N being an integer greater than one, a being an integer from one to N, the quantity Δφ(N, a) defining an a-th one of N codes, the integer a having different values in different SSFBGs in the transmitting communication device;
using the SSFBGs in the transmitting communication device to encode an optical pulse signals, thereby obtaining a plurality of encoded optical signals;
additively combining the plurality of encoded optical signals to generate a combined optical signal;
transmitting the combined optical signal to the receiving communication device; and
using the one SSFBG in the receiving communication device to decode the combined optical signal.

20. The optical code division multiplex communication method of claim 19, wherein for a certain positive integer a less than N:
the plurality of SSFBGs in the transmitting communication device include one SSFBG using the a-th one of the N codes and another SSFBG using the (a+2)-th one of the N codes; and
the one SSFBG in the receiving communication device uses the (a+1)-th one of the N codes.

21. The optical code division multiplex communication method of claim 19, wherein for a certain positive integer a less than N:
the plurality of SSFBGs in the transmitting communication device include one SSFBG using the a-th one of the N codes, another SSFBG using the (a+1)-th one of the N codes, and yet another SSFBG using the (a+2)-th one of the N codes; and
the one SSFBG in the receiving communication device uses the (a+1)-th one of the N codes.

22. The optical code division multiplex communication method of claim 19, wherein for a certain positive integer a less than N:
the plurality of SSFBGs in the transmitting communication device include one SSFBG using the a-th one of the N codes and another SSFBG using the (a+1)-th one of the N codes; and
the one SSFBG in the receiving communication device uses the a-th or the (a+1)-th one of the N codes.

23. An optical code division multiplex communication method for optical code division multiplex communication between a transmitting communication device having an SSFBG and a receiving communication device having a plurality of SSFBGs, each SSFBG among the at least one SSFBG and the plurality of SSFBGs having M mutually identical unit fiber Bragg gratings disposed in a single optical fiber so as to reflect a light pulse input to the single optical fiber, thereby dividing the light pulse into M chip pulses, the method comprising:
arranging the M unit fiber Bragg gratings in said each SSFBG at equal intervals such that the chip pulses produced by reflection by mutually adjacent ones of the M unit fiber Bragg gratings, differ in phase by a quantity Δφ(N, a) expressible as
Δφ(N, a)=2aπ/N
N being an integer greater than one, a being an integer from one to N, the quantity Δφ(N, a) defining an a-th one of N codes, the integer a having different values in different SSFBGs in the receiving communication device;
using the SSFBG in the transmitting communication device to encode an optical pulse signal, thereby obtaining an encoded optical signal;
transmitting the encoded optical to the receiving communication device;
using the plurality of SSFBGs in the receiving communication device to decode the encoded optical signal, thereby obtaining a plurality of decoded optical signals; and
additively combining the plurality of decoded optical signals.

24. The optical code division multiplex communication method of claim 23, wherein for a certain positive integer a less than N:
the SSFBG in the transmitting communication device includes an SSFBG using the (a+1)-th one of the N codes; and
the plurality of SSFBGs in the receiving communication device include one SSFBG using the a-th one of the N codes and another SSFBG using the (a+2)-th one of the N codes.

25. The optical code division multiplex communication method of claim 23, wherein for a certain positive integer a less than N:
the SSFBG in the transmitting communication device uses the (a+1)-th one of the N codes; and
the plurality of SSFBGs in the receiving communication device include one SSFBG using the a-th one of the N codes, another SSFBG using the (a+1)-th one of the N codes, and yet another SSFBG using the (a+2)-th one of the N codes.

26. The optical code division multiplex communication method of claim 23, wherein for a certain positive integer a less than N:
the SSFBG in the transmitting communication device uses the a-th or the (a+1)-th one of the N codes; and
the plurality of SSFBGs in the receiving communication device include one SSFBG using the a-th one of the N codes and another SSFBG using the (a+1)-th one of the N codes.
